(19) United States
(12) Patent Application Publication
(10) Pub. No.: US 2005/0068704 A1
(43) Pub. Date: Mar. 31, 2005

(54) Receiver apparatus and satellite broadcast reception system therewith

(76) Inventor: Masato Kozaki, Suita-shi (JP)

Correspondence Address: BIRCH STEWART KOLASCH & BIRCH, PO BOX 747, FALLS CHURCH, VA, 22040-0747, US

(21) Appl. No.: 10/947,237

(22) Filed: Sep. 23, 2004

(30) Foreign Application Priority Data
Sep. 26, 2003 (JP) 2003-334721

(51) Int. Cl. H02H 3/20

(52) U.S. Cl. 361/90

(57) ABSTRACT

A receiver apparatus has ports to which a plurality of receivers are individually detachably connected, a plurality of internal circuits having mutually different power supply paths; and a power supply circuit that receives electric power from the receivers and generates drive voltages for the internal circuits. According to how the receivers are connected and what models they are, each internal circuit is assigned a receiver from which to extract a current it consumes. With this configuration, even when the voltages fed from the plurality of receivers connected vary, the currents extracted therefrom do not vary, and the current feeding capacities of the individual receivers can be effectively exploited.

This nonprovisional application claims priority under 35 U.S.C. § 119(a) on Patent Application No. 2003-334721 filed in Japan on Sep. 26, 2003, the entire contents of which are hereby incorporated by reference.

### BACKGROUND OF THE INVENTION

1. Field of the Invention

The present invention relates to a receiver apparatus to which a plurality of receivers can be connected. In particular, the present invention relates to an LNB (low-noise block down converter) with which a satellite broadcast reception system is built.

2. Description of Related Art

FIG. 6 is a block diagram showing an example of a conventional LNB. The LNB 100 shown in this figure includes: a reception circuit 101 that extracts a plurality of channel signals from the satellite signals received via an unillustrated reflector, that then amplifies the extracted signals on a low-noise basis, and that then selects from the amplified signals those requested from receivers 200a and 200b to feed the selected signals thereto; a power supply circuit 102 that generates the supply voltage from which the LNB 100 operates; and ports 103a and 103b to which the receivers 200a and 200b are respectively connected. The power supply circuit 102 includes: diodes Da and Db of which the anodes are respectively connected to the ports 103a and 103b and of which the cathodes are connected together; and a regulator REG connected to the cathode of the diodes Da and Db.

In the LNB 100 configured as described above, the power supply circuit 102 receives, via the ports 103a and 103b, direct-current voltages Va and Vb from the receivers 200a and 200b. The regulator REG generates a predetermined voltage (for example 3 [V]) from the direct-current voltages Va and Vb, and then feeds the generated voltage to the relevant parts of the LNB 100.

The direct-current voltages Va and Vb are used not only as the input voltages to the regulator REG, but also as output select signals for the reception circuit 101, each of those voltages being shifted among a plurality of voltage levels (for example, between two levels of 13 [V] and 18 [V]) according to the frequency band of the desired channel signal. If the direct-current voltage Va is higher than the direct-current voltage Vb, the diode Da alone is on, and thus the direct-current voltage Va is fed to the regulator REG as the input voltage thereto; by contrast, if the direct-current voltage Vb is higher than the direct-current voltage Va, the diode Db alone is on, and thus the direct-current voltage Vb is fed to the regulator REG as the input voltage thereto.

Indeed, with the LNB 100 configured as described above, when reception channels are switched, even if there is a difference between the direct-current voltages Va and Vb respectively fed to the ports 103a and 103b, the rectifying action of the diodes Da and Db prevents backflow current from the higher-potential port to the lower-potential port, and thus prevents a receiver breakdown.

However, with the LNB 100 configured as described above, in which the currents Ia and Ib fed from the receivers 200a and 200b, of which a plurality is connected to the LNB 100, are simply added together for consumption, when there is a difference between the direct-current voltages Va and Vb, all the current consumed by the LNB 100 is extracted solely from the receiver that feeds it with the higher voltage, with no current whatsoever extracted from the other receiver. As a result, with the LNB 100 configured as described above, when reception channels are switched, every time the magnitudes of the direct-current voltages Va and Vb are reversed, the currents Ia and Ib vary greatly, producing noise, and thus resulting in malfunctioning of the LNB 100 and disturbances in received images.

To overcome this problem, the applicant of the present invention once disclosed and proposed a receiver apparatus which, when a plurality of receivers are connected thereto, extracts current from the receiver connected to a predetermined port with higher priority irrespective of the magnitudes of the direct-current voltages fed from the individual receivers, and a receiver apparatus in which the total current it consumes is equally apportion among different ports so that equal currents are extracted from a plurality of receivers connected thereto (see Japanese Patent Applications Laid-Open Nos. 2002-218329 and 2001-127661).

Indeed, with the receiver apparatuses disclosed in the patent publications mentioned above, when reception channels are switched, even if the magnitudes of the direct- current voltages fed from a plurality of receivers connected thereto vary, the currents extracted from the individual receivers do not vary. Thus, no noise is produced as leads to malfunctioning of the receiver apparatus or disturbances in received images.

However, with the receiver apparatus disclosed in Japanese Patent Application Laid-Open No. 2002-218329 mentioned above, the current feeding capacity of the receiver connected to a port other than the predetermined one cannot be exploited at all. Thus, when a receiver with a low current feeding capacity is connected to the predetermined port, even if a receiver with a higher current feeding capacity is connected to another port, the receiver apparatus may fail to operate normally because of an insufficient supply of current.

On the other hand, with the receiver apparatus disclosed in Japanese Patent Application Laid-Open No. 2001-127661 mentioned above, the total current it consumes is simply equally apportioned among different ports irrespective of what type of receiver is connected to each port. Thus, for example, when a plurality of receivers with different current feeding capacities are connected, the situation cannot be flexibly coped with as by extracting current from the receiver with the highest current feeding capacity with the highest priority. That is, the current feeding capacities of the individual receivers cannot be effectively exploited.

### SUMMARY OF THE INVENTION

In view of the conventionally experienced problems described above, it is an object of the present invention to provide a receiver apparatus that does not suffer from variations in the currents extracted from a plurality of receivers connected thereto even if the voltages fed from the individual receivers vary and that can effectively exploit the current feeding capacities of the individual receivers.

To achieve the above object, according to the present invention, a receiver apparatus is provided with: a plurality of external terminals to which receivers are individually detachably connected; a plurality of internal circuits having mutually different power supply paths; and a power supply circuit that receives electric power from the receivers and generates drive voltages for the internal circuits. Here, according to how the receivers are connected, or according to how the receivers are connected and what models the receivers are, the power supply circuit assigns each internal circuit a receiver from which to extract a current for consumption by the internal circuit.

### BRIEF DESCRIPTION OF THE DRAWINGS

FIG. 1 is a block diagram conceptually showing the configuration of an LNB according to the invention;

FIG. 2 is a block diagram showing an LNB 10 embodying the invention;

FIG. 3 is a circuit diagram showing the current control circuits 121 to 123 of a first embodiment of the invention;

FIG. 4 is a circuit diagram showing an example of the configuration of the switch SW1;

FIG. 5 is a block diagram showing the current control circuits 121 to 123 of a second embodiment of the invention; and

FIG. 6 is a block diagram showing an example of a conventional LNB.

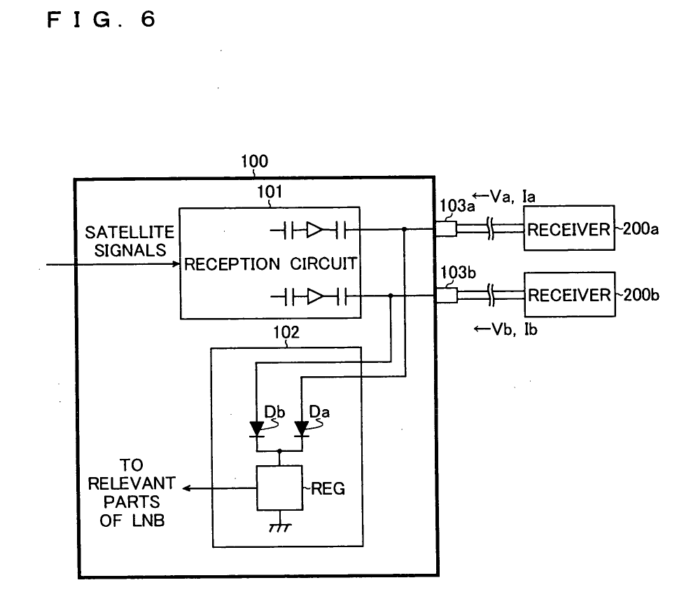

### DETAILED DESCRIPTION OF PREFERRED EMBODIMENTS

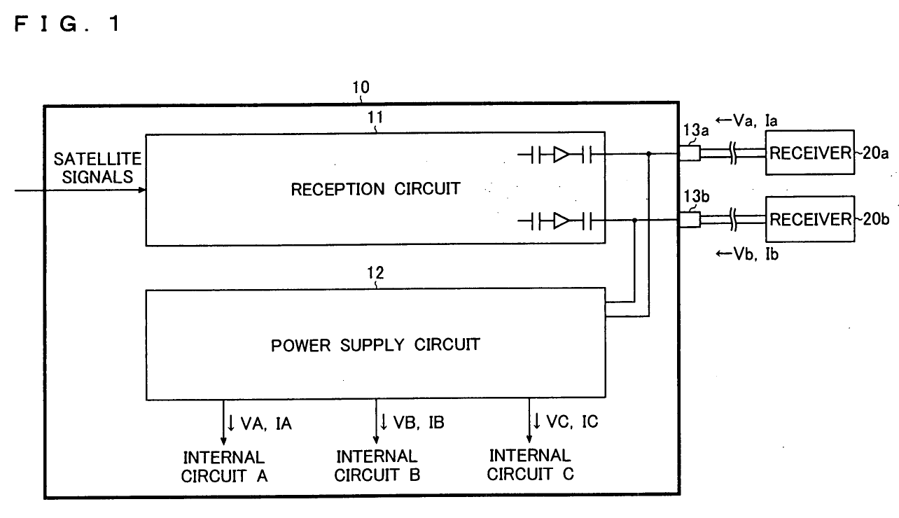

FIG. 1 is a block diagram conceptually showing the configuration of an LNB according to the present invention. As shown in this figure, the LNB 10 according to the invention includes: a reception circuit 11 that extracts a plurality of channel signals from the satellite signals received via an unillustrated reflector, that then amplifies the extracted signals on a low-noise basis, and that then selects from the amplified signals those requested from receivers 20a and 20b to feed the selected signals thereto; a power supply circuit 12 that generates the supply voltage from which the LNB 10 operates; and ports 13a and 13b to which the receivers 20a and 20b are respectively connected.

In the LNB 10 configured as described above, the power supply circuit 12 receives, via the ports 13a and 13b, direct-current voltages Va and Vb from the receivers 20a and 20b. The power supply circuit 12 generates predetermined direct-current voltages VA to VC (for example, 3 [V]) from the direct-current voltages Va and Vb, and feeds those voltages to internal circuits A to C that have mutually different power supply paths. The internal circuits A to C are circuit groups into which the various internal circuits of the LNB 10 are divided according to their power consumption and their relationship with the receivers. Thus, the internal circuits A to C include the components constituting the receiver circuit 11, namely an LNA (low-noise amplifier), local oscillator, mixer, selector, etc.

The direct-current voltages Va and Vb fed from the receivers 20a and 20b are used not only as the input voltages to the power supply circuit 12 but also as output select signals for the reception circuit 11, each of those voltages being shifted among a plurality of voltage levels (for example, between two levels of 13 [V] and 18 [V]) according to the frequency band of the desired channel signal.

Here, the power supply circuit 12 of the LNB 10 is so configured that, according to how the receivers 20a and 20b are connected, or according to how they are connected and what models they are, the internal circuits A to C, i.e., the circuit groups into which the various internal circuits of the LNB 10 are divided, are each assigned a receiver from which to extract the currents IA to IC they consume.

Classifying the internal circuits of the LNB 10 so as to divide their current consumption in this way makes it possible to apportion the current consumed by the LNB 10 more flexibly than ever between the receivers 20a and 20b. Specifically, while conventionally it is only possible either to extract all the current consumed by the LNB 10 from one receiver or to apportion it equally among all receivers, with the LNB 10 of the invention it is possible to cope more flexibly as by extracting the consumed current IA from the receiver 20a and the consumed current IB from the receiver 20b.

Thus, with the LNB 10 of the embodiment, from where to extract the consumed currents IA to IC are appropriately apportioned, with the result that, when reception channels are switched, even if there are variations in the magnitudes of the direct-current voltages Va and Vb fed from a plurality of receivers 20a and 20b connected to the LNB 10, the currents Ia and Ib extracted from the individual receivers 20a and 20b do not vary, and the current feeding capacities of the individual receivers 20a and 20b can be effectively exploited.

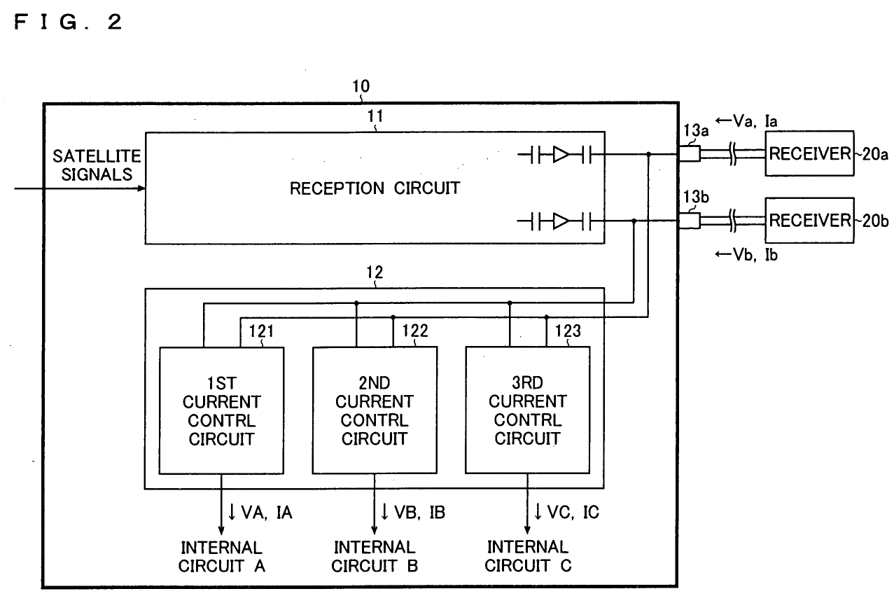

In the LNB 10 of the embodiment, the power supply circuit 12 is advisably, as shown in FIG. 2, so configured as to have a first to a third current control circuit 121 to 123 that, for the internal circuits A to C respectively, switch power supply paths by way of which they receive the supply voltages.

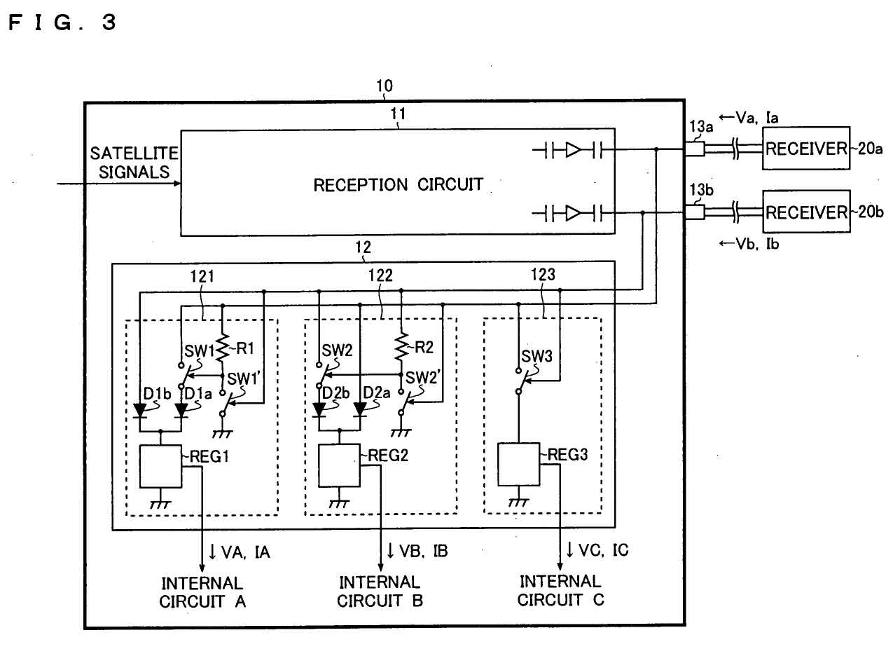

Next, the current control circuits 121 to 123 of a first embodiment of the invention will be described in detail with reference to FIG. 3. FIG. 3 is a circuit diagram showing the current control circuits 121 to 123 of the first embodiment.

As shown in this figure, the current control circuit 121 includes diodes D1a and D1b, a regulator REG1, switches SW1 and SW1′, and a resistor R1. The anode of the diode D1a is connected to one end of the switch SW1, and the anode of the diode D1b is connected to the port 13b. The cathodes of the diodes D1a and D1b are connected together, and the node between them is connected to the input terminal of the regulator REG1. The output terminal of the regulator REG1 is connected to the power input terminal of the internal circuit A. The other end of the switch SW1 is connected to the port 13a. One end of the resistor R1 is connected to the port 13a, and the other end of the resistor R1 is connected to the control terminal of the switch SW1, and is also connected to one end of the switch SW1′. The other end of the switch SW1′ is grounded. The control terminal of the switch SW1′ is connected to the port 13b.

The current control circuit 122 includes diodes D2a and D2b, a regulator REG2, switches SW2 and SW2′, and a resistor R2. The anode of the diode D2a is connected to the port 13a, and the anode of the diode D2b is connected to one end of the switch SW2. The cathodes of the diodes D2a and D2b are connected together, and the node between them is connected to the input terminal of the regulator REG2. The output terminal of the regulator REG2 is connected to the power input terminal of the internal circuit B. The other end of the switch SW2 is connected to the port 13b. One end of the resistor R2 is connected to the port 13b, and the other end of the resistor R2 is connected to the control terminal of the switch SW2, and is also connected to one end of the switch SW2′. The other end of the switch SW2′ is grounded. The control terminal of the switch SW2′ is connected to the port 13a.

The current control circuit 123 includes a regulator REG3 and a switch SW3. The input terminal of the regulator REG3 is connected to one end of the switch SW3, and the output terminal of the regulator REG3 is connected to the power input terminal of the internal circuit C. The other end of the switch SW3 is connected to the port 13a, and the control terminal of the switch SW3 is connected to the port 13b.

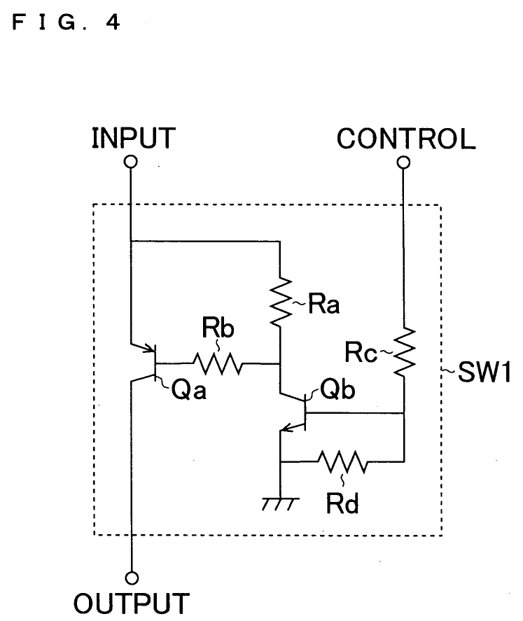

The switch SW1 includes, as shown in FIG. 4, a pnp-type bipolar transistor Qa, an npn-type bipolar transistor Qb, and resistors Ra to Rd. The emitter of the transistor Qa serves as the input terminal of the switch SW1, and is connected to one end of the resistor Ra. The collector of the transistor Qa serves as the output terminal of the switch SW1. The base of the transistor Qa is connected to one end of the resistor Rb. The other ends of the resistors Ra and Rb are connected together, and the node between them is connected to the collector of the transistor Qb. The emitter of the transistor Qb is connected to one end of the resistor Rd, and is also connected to ground. The base of the transistor Qb is connected to the other end of the resistor Rd, and is connected to one end of the resistor Rc. The other end of the resistor Rc serves as the control terminal of the switch SW1. Configured in this way, the switch SW1 turns on when it receives a high level at the control terminal thereof, and turns off when it receives a low level at the control terminal thereof. The switches SW1′, SW2, SW2′, and SW3 have the same configuration as described above, and perform on/off operation in the same manner as described above.

The LNB 10 configured as described above operates as follows when receivers are connected to both of the ports 13a and 13b. In the current control circuit 121, the application of the direct-current voltage Vb turns the SW1′ on and the switch SW1 off, cutting off the power supply path from the port 13a to the regulator REG1. That is, when a receiver is connected to the port 13b, the current control circuit 121 leaves alive the power supply path from the port 13b to the regulator REG1 and cuts off the other power supply path. Accordingly, the current IA consumed by the internal circuit A is extracted, with higher priority, from the receiver 20b connected to the port 13b.

In the current control circuit 122, the application of the direct-current voltage V1a turns the SW2′ on and the switch SW2 off, cutting off the power supply path from the port 13b to the regulator REG2. That is, when a receiver is connected to the port 13a, the current control circuit 122 leaves alive the power supply path from the port 13a to the regulator REG2 and cuts off the other power supply path. Accordingly, the current IB consumed by the internal circuit B is extracted, with higher priority, from the receiver 20a connected to the port 13a.

In the current control circuit 123, the application of the direct-current voltage V1b turns the switch SW3 on, establishing the power supply path from the port 13a to the regulator REG3. Accordingly, the current IC consumed by the internal circuit C is extracted from the receiver 20a connected to the port 13a.

In this way, in the LNB 10 configured as described above, when a plurality of receivers are connected thereto, the current control circuits 121 to 123 switch the power supply paths to the internal circuits A to C in such a way that no single internal circuit is connected to a plurality of receivers and simultaneously that not all the internal circuits are connected to a single receiver. With this configuration, even if there are variations in the voltages Va and Vb fed from a plurality of receivers 20a and 20b connected, the currents Ia and Ib respectively extracted therefrom do not vary. Thus, such variations in the currents do not produce noise as leads to malfunctioning of the LNB 10 or disturbances of the received images. Moreover, the current feeding capacities of the receivers 20a and 20b can be effectively exploited.

In the LNB 10 configured as described above, when a receiver 20a is connected only to the port 13a, in the current control circuit 121, the SW1′ is off and the switch SW1 is on, establishing the power supply path from the port 13a to the regulator REG1. In the current control circuit 122, the power supply path from the port 13a to the regulator REG2 is kept alive all the time. Accordingly, the currents IA and IB consumed by the internal circuits A and B are both extracted from the receiver 20a connected to the port 13a. In the current control circuit 123, the switch SW3 is off, and thus the supply of power to the internal circuit C is cut off.

In the LNB 10 configured as described above, when a receiver 20b is connected only to the port 13b, in the current control circuit 122, the SW2′ is off and the switch SW2 is on, establishing the power supply path from the port 13b to the regulator REG2. In the current control circuit 121, the power supply path from the port 13b to the regulator REG1 is kept alive all the time. Accordingly, the currents IA and IB consumed by the internal circuits A and B are both extracted from the receiver 20b connected to the port 13b. In the current control circuit 123, although the switch SW3 is on, no receiver 20a is connected to the port 13a, and therefore the supply of power to the internal circuit C is cut off.

That is, unlike the current control circuits 121 and 122, the current control circuit 123 feeds power to the internal circuit C only when receivers are connected to both of the ports 13a and 13b, in other words, only when the receivers have a sufficiently high power feeding capacity. In this way, by suppressing, when the power feeding capacity is insufficient, the supply of power to the circuits whose operation is not essential to the operation of the LNB 10 or whose power consumption is high (here, the internal circuit C), it is possible to enhance the operation stability of the LNB 10 and to reduce the power consumption.

In the current control circuits 121 to 123 configured as described above, the switching of the power supply paths for different internal circuits is achieved by the use of electronic switches such as transistors that are opened and closed according to whether or not direct-current voltages are present at given ports. With this configuration, the power supply circuit 12 can on its own apportion the consumed current according to how receivers are connected without waiting for instructions from a microcomputer or the like.

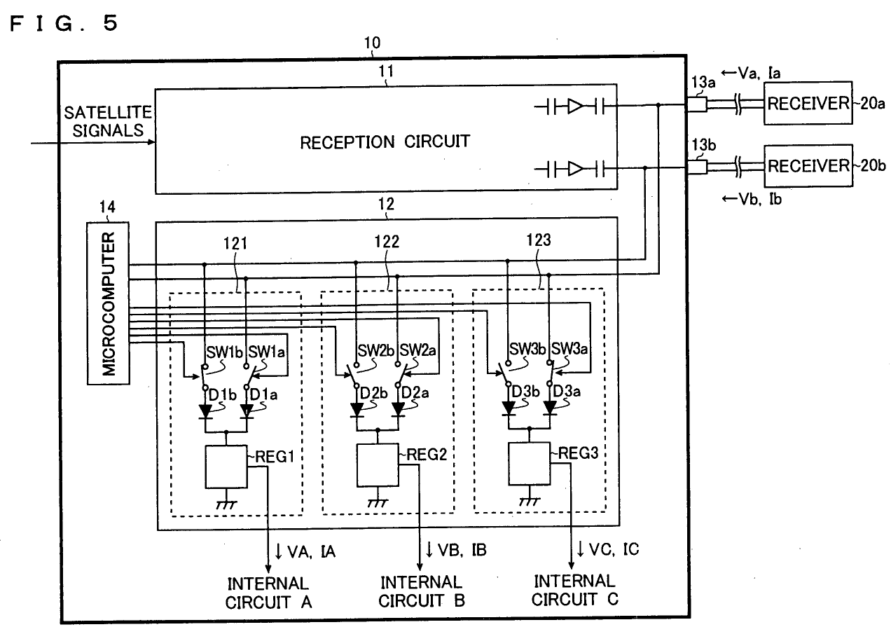

Next, the current control circuits 121 to 123 of a second embodiment of the invention will be described in detail with reference to FIG. 5. FIG. 5 is a circuit diagram showing the current control circuits 121 to 123 of the second embodiment.

As shown in this figure, the current control circuit 121 includes diodes D1a and D1b, a regulator REG1, and switches SW1a and SW1b. The anode of the diode D1a is connected to one end of the switch SW1a, and the anode of the diode D1b is connected to one end of the switch SW1b. The cathodes of the diodes D1a and D1b are connected together, and the node between them is connected to the input terminal of the regulator REG1. The output terminal of the regulator REG1 is connected to the power input terminal of the internal circuit A. The other end of the switch SW1a is connected to the port 13a, and the other end of the switch SW1b is connected to the port 13b. The control terminals of the switches SW1a and SW1b are connected to a microcomputer 14 that recognizes how receivers are connected and what models they are.

The current control circuit 122 includes diodes D2a and D2b, a regulator REG2, and switches SW2a and SW2b. The anode of the diode D2a is connected to one end of the switch SW2a, and the anode of the diode D2b is connected to one end of the switch SW2b. The cathodes of the diodes D2a and D2b are connected together, and the node between them is connected to the input terminal of the regulator REG2. The output terminal of the regulator REG2 is connected to the power input terminal of the internal circuit B. The other end of the switch SW2a is connected to the port 13a, and the other end of the switch SW2b is connected to the port 13b. The control terminals of the switches SW2a and SW2b are connected to the microcomputer 14.

The current control circuit 123 includes diodes D3a and D3b, a regulator REG3, and switches SW3a and SW3b. The anode of the diode D3a is connected to one end of the switch SW3a, and the anode of the diode D3b is connected to one end of the switch SW3b. The cathodes of the diodes D3a and D3b are connected together, and the node between them is connected to the input terminal of the regulator REG3. The output terminal of the regulator REG3 is connected to the power input terminal of the internal circuit C. The other end of the switch SW3a is connected to the port 13a, and the other end of the switch SW3b is connected to the port 13b. The control terminals of the switches SW3a and SW3b are connected to the microcomputer 14.

In the LNB 10 configured as described above, before giving instructions to the current control circuits 121 to 123, the microcomputer 14 recognizes not only how receivers are connected but also the models of the connected receivers as identified from their respective model numbers or the like, and then, according to the current feeding capacities of the individual receivers, determines from which receivers to extract the currents IA to IC consumed by the internal circuit A to C.

In the case specifically shown in FIG. 5, the microcomputer 14 instructs the current control circuit 121 to turn the switch SW1a off and the switch SW1b on. Thus, in the current control circuit 121, the power supply path from the port 13a to the regulator REG1 is cut off, and accordingly the current IA consumed by the internal circuit A is extracted, with higher priority, from the receiver 20b connected to the port 13b. The microcomputer 14 also instructs the current control circuit 122 to turn both the switches SW2a and SW2b off. Thus, in the current control circuit 122, the power supply path to the regulator REG2 is completely cut off, and accordingly no current is extracted for consumption by the internal circuit B. The microcomputer 14 also instructs the current control circuit 123 to turn the switch SW3a on and the switch SW3b off. Thus, in the current control circuit 123, the power supply path from the port 13b to the regulator REG3 is cut off, and accordingly the current IC consumed by the internal circuit C is extracted, with higher priority, from the receiver 20a connected to the port 13a.

As described above, the LNB 10 of this embodiment includes the microcomputer 14 that recognizes how receivers are connected and what models they are and that then sends instructions to the current control circuits 121 to 123. According to the instructions from the microcomputer 14, the current control circuits 121 to 123 switch the power supply paths to the individual internal circuits A to C in such a way that no single internal circuit is connected to a plurality of receivers and simultaneously that not all the internal circuits are connected to a single receiver.

With this configuration, as in the first embodiment described earlier, even when there are variations in the direct-current voltages Va and Vb fed from a plurality of receivers 20a and 20b connected to the LNB 10, the currents Ia and Ib extracted therefrom do not vary, and the current feeding capacities of the individual receivers 20a and 20b can be effectively exploited. In addition, with the LNB 10 of this embodiment, according to how receivers are connected and what models they are, it is possible to cut off the supply of power to the circuits whose operation is not essential to the operation of the LNB 10 or whose power consumption is high (here, the internal circuit B). This makes it possible to enhance the operation stability of the LNB 10 and to reduce the power consumption.

Moreover, in this embodiment, the microcomputer 14 is so configured that, when a plurality of receivers are connected, the current control circuits 121 to 123 are instructed to extract the currents consumed by the internal circuits A to C with higher priority from the receivers with higher current feeding capacities. In this way, the LNB 10 of this embodiment is designed for use not only in cases where a plurality of identical receivers are connected thereto but also in cases where a plurality of receivers with different current feeding capacities are connected thereto. Thus, instead of simply equally apportioning the total current consumed by the LNB 10, it is possible to flexibly cope with the different current feeding capacities of the receivers, and thus to effectively exploit the current feeding capacities of the individual receivers.

As described earlier, the current control circuits 121 to 123 advisably include: regulators REG1 to REG3 that generate the drive voltages VA to VC for the internal circuits A to C; and switches SW1a to 3a and SW1b to 3b that open and close the power supply paths from the ports 13a and 13b to the regulators REG1 to REG3 according to instructions from the microcomputer 14. With this configuration, it is possible to achieve, with a comparatively simple circuit configuration, the switching of the power supply paths according to instructions from the microcomputer 14.

The embodiments described above deal with cases where two receivers are connected to the LNB 10, and the internal circuits of the LNB 10 are classified into three groups. It should be understood, however, that the present invention may be implemented in any other configuration; that is, any number of receivers may be connected, and the internal circuits may be classified into any number of groups.

The configuration and operation of the power supply circuit may be designed in any other manner than in the embodiments described above so long as from where to extract the currents consumed by different internal circuits can be apportioned among different receivers according to how the receivers are connected and what models they are.

The embodiments described above deal with cases where the present invention is applied to an LNB used to build a satellite broadcast reception system. It is to be understood, however, that the application of the present invention is not limited to such cases; that is, the present invention finds wide application in reception apparatuses in general to which a plurality of receivers are connected.

As described above, with a reception apparatus according to the invention, even when there are variations in the voltages fed from a plurality of receivers connected, the currents extracted therefrom do not vary, and the current feeding capacities of the individual receivers can be effectively exploited.

The present invention is suitable for an LNB or the like used to build a satellite broadcast reception system, and is a very useful as a means for preventing malfunctioning of the apparatus and disturbances in received images.

1. A receiver apparatus comprising:
a plurality of external terminals to which receivers are individually detachably connected;
a plurality of internal circuits having mutually different power supply paths; and
a power supply circuit that receives electric power from the receivers and generates drive voltages for the internal circuits,
wherein, according to how the receivers are connected, or according to how the receivers are connected and what models the receivers are, the power supply circuit assigns each internal circuit a receiver from which to extract a current for consumption by the internal circuit.

2. The receiver apparatus of claim 1, wherein the power supply circuit includes:
a current control circuit that switches, individually for each internal circuit, the power supply paths to the internal circuits.

3. The receiver apparatus of claim 2, wherein, when a plurality of receivers are connected, the current control circuit switches the power supply paths to the individual internal circuits in such a way that no single internal circuit is connected to a plurality of receivers and simultaneously that not all internal circuits are connected to a single receiver.

4. The receiver apparatus of claim 3, wherein the current control circuit includes:
a regulator that generates the drive voltages for the internal circuits; and
a switch portion that, when a receiver is connected to a given external terminal, cuts off, except the power supply path from the given external terminal to the regulator, all the power supply paths from the other external terminals to the regulator.

5. The receiver apparatus of claim 4, wherein the switch portion includes:
an electronic switch that opens and closes according to whether or not a direct-current voltage fed to the given external terminal is present.

6. The receiver apparatus of claim 2, further comprising:
a microcomputer that recognizes how the receivers are connected, or how the receivers are connected and what models the receivers are, and that then gives an instruction to the current control circuit,
wherein, according to the instruction from the microcomputer, the current control circuit switches the power supply paths to the individual internal circuits in such a way that no single internal circuit is connected to a plurality of receivers and simultaneously that not all internal circuits are connected to a single receiver.

7. The receiver apparatus of claim 6, wherein, when a plurality of receivers are connected, the microcomputer instructs the current control circuit to extract the currents for consumption by the internal circuits with higher priority from the receivers with higher current feeding capacities.

8. The receiver apparatus of claim 6, wherein the current control circuit includes:
a regulator that generates the drive voltages for the internal circuits; and
a switch portion that, according to the instruction from the microcomputer, individually opens and closes the power supply paths from the external terminals to the regulator.

9. A satellite broadcast reception system comprising:
a reception apparatus that extracts a plurality of channel signals from satellite signals received via a reflector, that then amplifies the extracted channel signals on a low-noise basis, and that then selects from the amplified channel signals those requested by receivers,
wherein the receiver apparatus includes:
a plurality of external terminals to which the receivers are individually detachably connected;
a plurality of internal circuits having mutually different power supply paths; and
a power supply circuit that receives electric power from the receivers and generates drive voltages for the internal circuits,
wherein, according to how the receivers are connected, or according to how the receivers are connected and what models the receivers are, the power supply circuit assigns each internal circuit a receiver from which to extract a current for consumption by the internal circuit.

10. The satellite broadcast reception system of claim 9, wherein the power supply circuit includes:
a current control circuit that switches, individually for each internal circuit, the power supply paths to the internal circuits.

11. The satellite broadcast reception system of claim 10, wherein, when a plurality of receivers are connected, the current control circuit switches the power supply paths to the individual internal circuits in such a way that no single internal circuit is connected to a plurality of receivers and simultaneously that not all internal circuits are connected to a single receiver.

12. The satellite broadcast reception system of claim I 1, wherein the current control circuit includes:
a regulator that generates the drive voltages for the internal circuits; and
a switch portion that, when a receiver is connected to a given external terminal, cuts off, except the power supply path from the given external terminal to the regulator, all the power supply paths from the other external terminals to the regulator.

13. The satellite broadcast reception system of claim 12, wherein the switch portion includes:
an electronic switch that opens and closes according to whether or not a direct-current voltage fed to the given external terminal is present.

14. The satellite broadcast reception system of claim 10, wherein the reception apparatus further includes:
a microcomputer that recognizes how the receivers are connected, or how the receivers are connected and what models the receivers are, and that then gives an instruction to the current control circuit,
wherein, according to the instruction from the microcomputer, the current control circuit switches the power supply paths to the individual internal circuits in such a way that no single internal circuit is connected to a plurality of receivers and simultaneously that not all internal circuits are connected to a single receiver.

15. The satellite broadcast reception system of claim 14, wherein, when a plurality of receivers are connected, the microcomputer instructs the current control circuit to extract the currents for consumption by the internal circuits with higher priority from the receivers with higher current feeding capacities.

16. The satellite broadcast reception system of claim 14, wherein the current control circuit includes:
a regulator that generates the drive voltages for the internal circuits; and
a switch portion that, according to the instruction from the microcomputer, individually opens and closes the power supply paths from the external terminals to the regulator.
